(19) United States
(12) Patent Application Publication
(10) Pub. No.: US 2026/0238594 A1
(43) Pub. Date: Aug. 13, 2026

(54) DYNAMIC PRIORITIZATION OF PACKETS FROM DATA SOURCES

(71) Applicant: Hewlett Packard Enterprise Development LP, Spring, TX (US)

(72) Inventors: Derek Alan Sherlock, Fort Collins, CO (US); Frank R. Dropps, Annandale, MN (US); Trieu Quang Nguyen, Saint Anthony, MN (US); Glendon L. Akins, III, Fort Collins, CO (US)

(21) Appl. No.: 19/048,455

(22) Filed: Feb. 7, 2025

(51) Int. Cl. H04L 47/12; H04L 43/0882; H04L 45/00; H04L 47/24

(52) U.S. Cl. CPC H04L 47/12; H04L 43/0882; H04L 45/34; H04L 47/2458

(57) ABSTRACT

Methods and systems relate to receiving, at a network device, first packets from a first source and second packets from a second source. The network device decrements an index by a first value for each flit transmitted and increments the index by a second value for each unused segment transmitted in a flit. Selection circuitry of the network device select one or more packets from the first packets or the second packets to output from the network device. The selection is configured to prioritize fairness between the first source and the second source when the index is less than or equal to a threshold and to prioritize bandwidth usage when the index is greater than the threshold.

### BACKGROUND

Local area networks (LANs) and/or other networks include multiple network devices connected together. Often these networks may utilize network switches to enable connections between network sources and destinations.

### DRAWINGS

Features, aspects, and advantages of the present disclosure will become better understood when the following detailed description is read with reference to the accompanying drawings in which like characters represent like parts throughout the drawings, wherein:

FIG. 1 is a block diagram of a system that includes a network device/switch that receives data packets from multiple sources for a destination, in accordance with aspects of the present disclosure;

FIG. 2 is a block diagram of a system (e.g., the network device/switch of FIG. 1) that includes ASIC(s) that includes prioritization circuitry to dynamically prioritize packet transmission based on fairness and bandwidth usage, in accordance with aspects of the present disclosure;

FIG. 3 is a block diagram of circuitry of a network device (e.g., the ASIC(s) of FIG. 2), in accordance with aspects of the present disclosure;

FIG. 4 is a flow diagram of a process that may be deployed by processing resources and/or circuitry in network operations to implement dynamic prioritization, in accordance with aspects of the present disclosure;

FIG. 5 is a flow diagram of a process that may be deployed by processing resources and/or circuitry in network operations to implement dynamic prioritization, in accordance with aspects of the present disclosure; and

FIG. 6 is an example of dynamic prioritization (e.g., using the process of FIG. 5), in accordance with aspects of the present disclosure.

### DETAILED DESCRIPTION

Aspects provided herein relate to techniques for balancing transmissions between two or more sources by balancing priorities between fairness and maximizing an output bandwidth based on numbers of unused segments of sent transmissions. Fairness is the principle that each device/user in a network receives equal (i.e., fair) share of system resources. In other words, fairness measures are used to make sure that data is equally derived from different sources in a network when arbitering between the sources. Furthermore, some congestion control mechanisms of some network transfer protocols, such as the Transmission Control Protocol (TCP), may demand fairness as part of the protocol to avoid problems such as congestion collapse. Thus, the switch may impose fairness to comply with such protocols and/or avoid such unfairness issues, such as congestion collapse.

Additionally or alternatively, the arbitration may be between different paths in a single switch of a switch network even when the single switch acts as at least one of the sources. For instance, the switch may be a chassis switch that uses a fabric to couple together multiple network switch processing circuitries (e.g., ASICs) and arbitrates which paths in the fabric are to be drawn from. The switch(es) may apply fairness techniques, such as using deficit arbitration, until an output bandwidth falls below a threshold level. For instance, the network switch(es) may track how many transmitted segments are empty indicating unused bandwidth. When the output bandwidth falls below the threshold, the switch(es) change to prioritizing bandwidth over fairness until the threshold (or a different threshold) is crossed. These thresholds may be programmable thresholds that can be tuned in the field using at least one processing resource of the switch(es).

Incoming and outgoing interfaces handle packet content in flits. Each flit corresponds to the amount of packet data that an interface can supply (if an incoming interface) or consume (if an outgoing interface) in a single clock cycle. Packets may have variable lengths, varying from less than one flit, to many flits, and packets lengths are not necessarily an exact integer multiple of the length of a flit. When reaching a packet boundary at an output, a selection technique such as deficit round robin arbitration is used to select which input packet to select next, in order to equitably share the available output bandwidth between the streams of packets arriving from the competing sources. Consequently, a longer packet may begin in one output flit and end in a later output flit. When an output packet ends mid-flit on the output interface, output bandwidth efficiency is to be utilized by starting to send another packet, if available, within the same output flit to avoid wasting the remainder (e.g., a segment that may be 1/Nth of the flit) of the partially-utilized flit. The entirety of a short packet may fit within an output flit, leaving space to begin another packet in the same flit, in which case either (a) two packets, one from each source, be selected concurrently, or (b) if a single packet is selected, a part of the output’s bandwidth may be wasted due to a failure to completely fill the output flit with useful packet data due to unused segments. If, in that case, the two available packets from the two sources are of unequal lengths, the selection of both implicitly makes available a larger share of the output bandwidth to whichever source presents the longer of the two packets. This decision which may help or hinder fairness, depending upon which source has previously fallen behind in its access to a fair share of the output bandwidth. In other words, such selection techniques may be unsuitable for ensuring fairness and/or may fail bandwidth targets.

Indeed, when balancing fairness and bandwidth utilization, the two may be at odds. For example, when one source has a longer packet (e.g., 3 segments) and another has a single segment packet, bandwidth may be optimized by sending a packet from each source. The source that supplies the longer packet sends more data than the source that supplies the shorter packet. If the source supplying the shorter packet had already fallen behind its fair share of the output bandwidth, as indicated by the deficit arbiter, this imbalance would further exacerbate the unfairness. In effect, output bandwidth has been prioritized over fairness between the competing sources. Alternatively in such a situation, the arbiter may choose to send the shorter packet without the longer packet in the event its source has fallen behind in the deficit arbitration. This may result in wasted output bandwidth due to a partially-utilized output flit, but helps mitigate prior unfairness, by allowing the disadvantaged source an opportunity to reduce its deficit. Thus, one technique may be unsuitable for bandwidth and/or may be unsuitable for bandwidth utilization.

To address this dichotomy, a network switch may be used to alternate between prioritizing fairness and prioritizing fairness depending on some index value tracking operation. In implementation, a programmable parameter (N) may be used to impose an upper bound on the frequency at which unused segments may be sent to prioritize fairness. For each unused segment in an output flit that results directly from fairness-emphasizing policy, the value N is added to a cumulative index. Unused segments are counted in this manner if they could have been filled by the selection of an available second packet from another source. Subsequently and/or simultaneously, the index is decremented by one. Over time, the index increases if the rate of lost output bandwidth attributable to fairness policy exceeds one segment for every N flits (e.g., 1 per clock cycle) and decreases if that rate is lower than one segment for every N flits. The value N may be set to represent the tolerable mean time between lost segments, which is inversely proportional to the tolerable output bandwidth loss. For instance, if a single unused segment of a two-segment wide flit occurs every 5 cycles, the unused segments may account for a 10% bandwidth loss. A setting of N=5 would be appropriate if an output bandwidth of 90% is desired. Although this single example is discussed, different settings may be used for N to achieve different output bandwidth targets for the sake of fairness.

Returning to the conditions under which an arbiter is forced to choose between selecting two concurrent packets for emphasizing output bandwidth versus a single packet for emphasizing fairness between sources. For this to be a consideration, the sources present packets of unequal lengths, with the shorter of the two being favored by deficit arbitration and fitting entirely in the available space in the output flit, leaving at least one additional segment of available space in the output flit that could potentially be filled by the start of the longer packet. Since this exact set of circumstances may be relatively infrequent, wasted flits in output segments may generally be infrequent. However, worst-case patterns of arriving packet lengths may be problematic if not handled properly. For this reason, a mechanism may be used to allow the arbiter to ignore occasional infrequent lost segments when fairness gets too imbalanced and to recognize and react to a sustained pattern of frequently recurring ones. For instance, a programmable threshold (M) may be used to indicate an upper bound on the cumulative index

As long as a balance may be struck with optimization, this cumulative index may remain near 0. However, if a pattern emerges where source selection fairness continues to make the bandwidth worse, the network switch may begin to enforce bandwidth prioritization. If this index climbs over the threshold M (e.g., 15), bandwidth may be prioritized over fairness until the index falls back below the threshold M or another threshold value providing some amount of hysteresis. Thus, when the index is above the threshold M, bandwidth is prioritized while fairness is prioritized when the index is below the threshold M.

In some implementations, when the index is equal to the threshold M, one set priority may be used. For example, when the index is less than or equal to the threshold M, fairness may be prioritized while bandwidth is prioritized when the index is above the threshold M. Alternatively, in some implementations, when the index is greater than or equal to the threshold M, bandwidth may be prioritized while fairness is prioritized when the index is less than the threshold M.

In some implementations, the prioritization may remain unchanged while the index is equal to the threshold M. In such implementations, fairness may be prioritized when the index equals the threshold M when the index approaches the threshold M from below the threshold. However, bandwidth may be prioritized when the index equals the threshold M when the index approaches the threshold M from above the threshold M. In other words, in such implementations, prioritization in selecting which source to draw from does not change when the index equals the threshold M unless the index crosses the threshold.

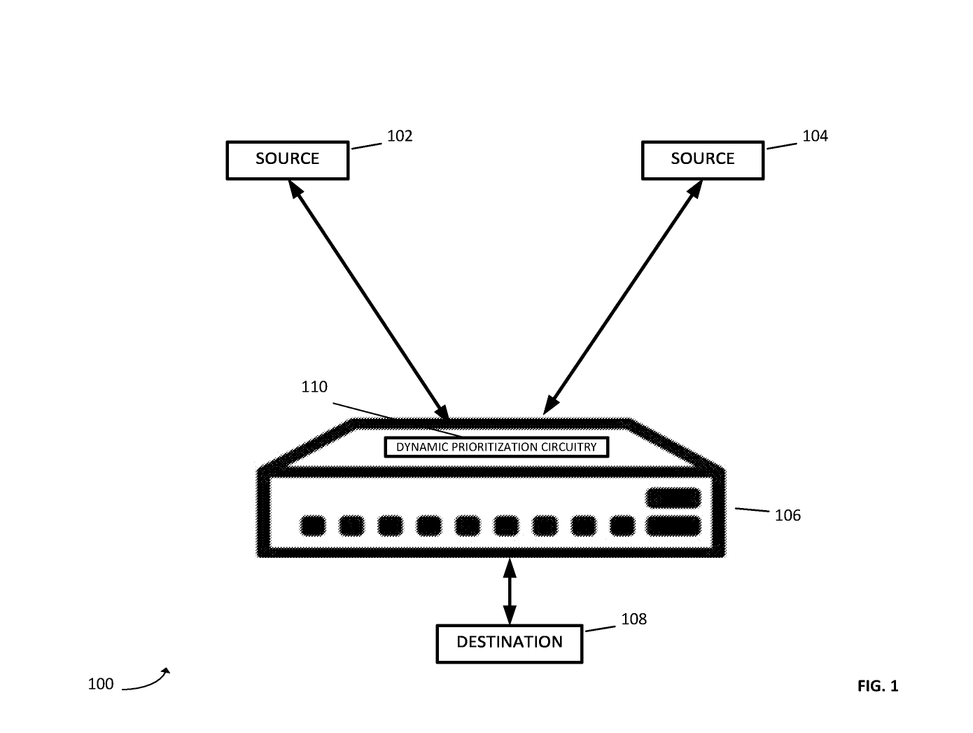

With the foregoing in mind, FIG. 1 is a diagram illustrating a system 100 that includes data sources 102 and 104 coupled to a network switch 106. The data sources 102 and 104 may generate data and/or forward data to the network switch 106. The data sources 102 and 104 may include any suitable network device, such as a client device, a server, a switch, and/or other device that may send its own data and/or data from another device to the network switch 106. In certain implementations, the data sources 102 and/or 104 may be located within the network switch 106. For instance, the data sources 102 and/or 104 may be data paths inside of the network switch 106 that forward data received from outside (e.g., via different ports). For example, the data sources 102 and/or 104 may be different pathways and/or chips within a network switch 106.

In some implementations, the network switch 106 may also route at least some data to the data sources 102 and/or 104 from other devices. In other words, although the data sources 102 and/or 104 provide data to the network switch 106, at least some of the time, the network switch 106 may also transmit data (e.g., responses or other messages) back to the data sources 102 and/or 104. Thus, data sources 102 and/or 104 may perform multiple roles at different times including data sources at some times and data recipient at other times.

Regardless of architecture, the network switch 106 may arbitrate which of the data sources 102 and 104 are to be transmitted to a destination 108. The destination 108 may be a separate network device and/or may be another portion (e.g., a pathway or ASIC) of the network switch 106 short of a final destination. Like the data sources 102 and/or 104, the destination 108 may act differently at different times. For instance, it may be the destination for some packets at one time while it is the source for other packets at another time.

In some implementations, the data source 102 and/or the data source 104 may be the originator of the data. In other implementations, the data source 102 and/or the data source 104 may merely be the immediate source of the data for the network switch 106 without originating the data. For instance, the data source 102 and/or the data source 104 may redirect or forward the data from another source. Similarly, the destination 108 may be final destination for packets sent from the network switch 106 or may be an intermediate destination that will ultimately be forwarded to the final destination by other device(s).

The data source 102, the data source 104, the network switch 106, and/or the destination 108 may be part of or connected using one or more networks. The one or more networks include multiple electronic devices and/or connections between devices through which communication may be made. The one or more networks may be entire networks on their own and/or may be network segments that are a part of larger networks. In some implementations, the data source 102, the data source 104, the network switch 106, and/or the destination 108 may be in different networks that use the inter-network connections as communication pathways between their respective networks.

As discussed below, the network switch 106 includes dynamic prioritization circuitry 110 that dynamically selects how to prioritize packets from the data sources 102 and 104. The dynamic prioritization circuitry 110 may include integrated circuits (e.g., ASIC(s)) and/or one or more processing resources to track fairness and/or bandwidth usage efficiency. In some implementations, dynamic prioritization circuitry 110 may be included within an integrated circuit (e.g., ASIC) with other parts of the network switch 106. Based on these tracked values, the dynamic prioritization circuitry 110 may dynamically choose between two or more priority schemes. For instance, a first scheme may prioritize fairness in selecting between the source 102 and the source 104 so that they are each able to provide similar amounts of data to the network switch 106 over time. The first priority scheme prioritizes fairness even if some segments of flits are unused for the sake of fairness since packing empty segments after a used segment may be unable to address a fairness imbalance. In fact, this packing may exacerbate such issues if the packet used to fill the empty segment is larger than the packet sent in the earlier segment(s).

A second priority scheme may disfavor fairness to some degree more than the first priority scheme. For instance, the second priority scheme may prioritize bandwidth usage efficiency over empty segments even if the results end up being unfair source selection, such as destination 108 receiving more data from at least one source than the other source. As such, the second priority scheme may be a bandwidth-usage-based priority scheme that is used when fairness has impacted the output efficiency and/or when the network switch 106 is to push more data through to destination 108 for some period of time.

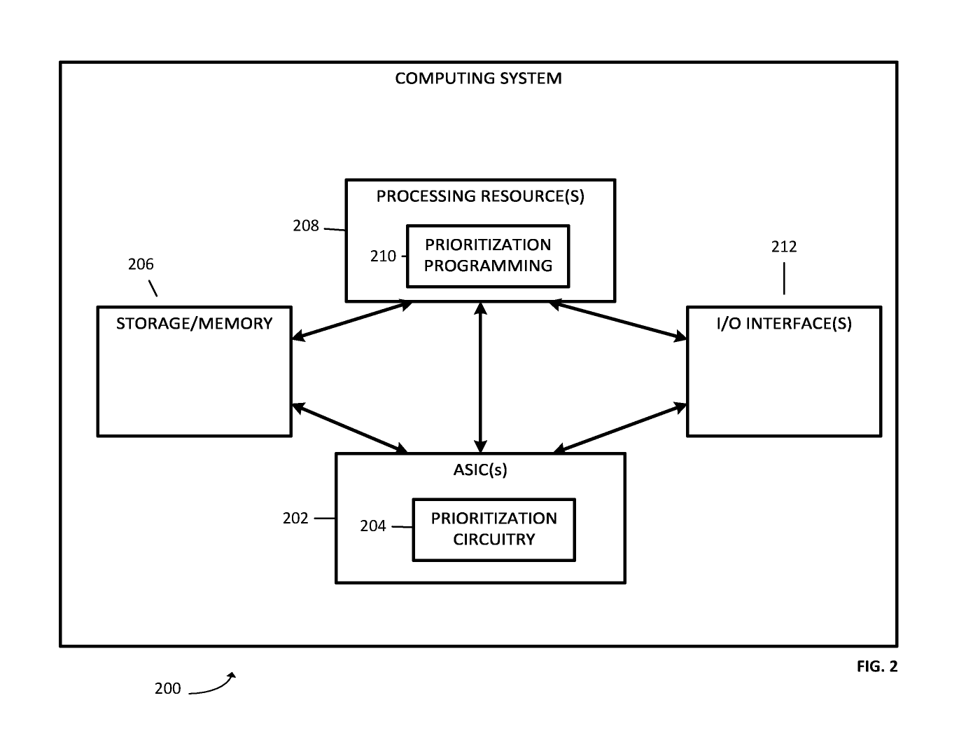

FIG. 2 is a diagram illustrating a computing system 200 that may be used to implement network arbitration. For example, the computing system 200 may be implemented as part of any network device, such as the network switch 106 of FIG. 1. The computing system 200 includes one or more application specific integrated circuits (ASICs) 202. In some implementations, the computing system 200 may supplement and/or replace the ASICs with other processing resources, such as processors, programmable logic devices (e.g., FPGAs and CPLDs), and the like. The one or more ASICs 202 may include an integrated circuit that is purpose built to provide network throughput through the network switch 106. These ASICs 202 may be chips that may be optimized for a particular type of connection, such as Ethernet. These ASICs 202 may connect to multiple processing resources 208 that may or may not provide prioritization programming 210 allowing communications between processing resources 208. These ASICs 202 may include on-chip buffering that includes policy tables used to specify policies on which packets are forwarded and/or prioritized and which are blocked or dropped. The one or more ASICs 202 may also implement flow tables that track flows through the one or more ASICs 202.

The one or more ASICs 202 include prioritization circuitry 204 that the one or more ASICs 202 use to prioritize which packets to deliver from multiple sources for inclusion in a flit. The prioritization circuitry 204 may include the flow tables and/or the policy tables. Alternatively, the prioritization circuitry 204 may be separate from the flow tables and/or policy tables. Using the prioritization circuitry, the policy tables, and/or flow tables, the one or more ASICs 202 implements dynamic prioritization to determine which packets to deliver first depending on some tracked fairness and/or efficiency.

In addition to any on-chip buffers of the one or more ASICs 202, the computing system 200 also includes storage/memory 206 to which the one or more ASICs 202 may have access. The storage/memory 206 may include any suitable articles of manufacture suitable for storing data and/or executable instructions. For instance, the storage/memory 206 may include a storage device, such as a Non-Volatile Memory Express (NVMe) device, a hard disk drive (HDD), a solid-state drive (SSD), an optical drive, flash memory, read-only memory (ROM), or any combination thereof. The storage/memory 206 includes memory that may include any suitable class of memory devices, such as a double data rate type 5 (DDR5) synchronous dynamic random-access memory (SDRAM) device, double data rate type 4 (DDR4) SDRAM device, low-power double data rate (LPDDR) SDRAM device, another suitable type of memory device, or any combination thereof. In some implementations, the one or more ASICs 202 store the policy table, the flow table, settings, and/or other data used in controlling how the one or more ASICs 202, and thus the computing system 200 behaves in prioritizing how packets are to be prioritized in forwarding of the packets.

The computing system 200 also includes one or more processing resources 208. The one or more processing resources 208 may include a central processing unit (CPU), a graphics processing unit (GPU), a processor implemented using a field programmable gate array (FPGA) or other programmable logic device, another processor type, or a combination thereof. The one or more processing resources 208 may be operably coupled with the storage/memory 206 to facilitate the use of the one or more processing resources 208 to implement various stored programs. Such programs or instructions executed by the one or more processing resources 208 may be stored in any suitable article of manufacture that includes one or more non-transitory and computer-readable media at least collectively storing the instructions or routines.

In addition, programs encoded on such a computer program product of the articles of manufacture may also include instructions that may be executed by the one or more processing resources 208 to enable the computing system 200 to provide various functionalities. For instance, the programs implemented by the one or more processing resources 208 using the instructions stored on the non-transitory, computer-readable medium of the storage/memory 206 may be used to perform prioritization programming 210 used to program the prioritization to be performed dynamically based on tracked bandwidth usage efficiency and/or fairness between data sources. For instance, the processing resources 208 may use the instructions stored in the storage/memory 206 to create or change programmable thresholds or increments that are used to weight empty or partially empty flits and/or a permitted amount of inefficiency to prioritize fairness within the permitted amount of inefficiency.

The computing system 200 also includes input-output (I/O) interfaces 212 that enable other remote devices and/or a user to transmit data to and/or receive data from the computing system 200. The I/O interfaces 212 couple to multiple devices. This connection to multiple devices and selective packet forwarding via the one or more ASICs 202 enable the computing system 200 to act as a switch for other devices connected to the computing system 200 via the I/O interfaces 212. The I/O interfaces 212 may include, for example, one or more network interfaces for a personal area network (PAN), such as a Bluetooth network, for a local area network (LAN) or wireless local area network (WLAN), such as an IEEE 802.11x Wi-Fi network, an IEEE 802.15.4 wireless network, an Ethernet network, and/or for a wide area network (WAN), such as a cellular network. The I/O interfaces 212 may additionally or alternatively include one or more interfaces for, for example, broadband fixed wireless access networks (WiMAX), mobile broadband Wireless networks (mobile WiMAX), and so forth. The I/O interfaces 212 may include additional interface types, such as a Universal Serial Bus (USB) interface, a coaxial cable interface, or a combination thereof.

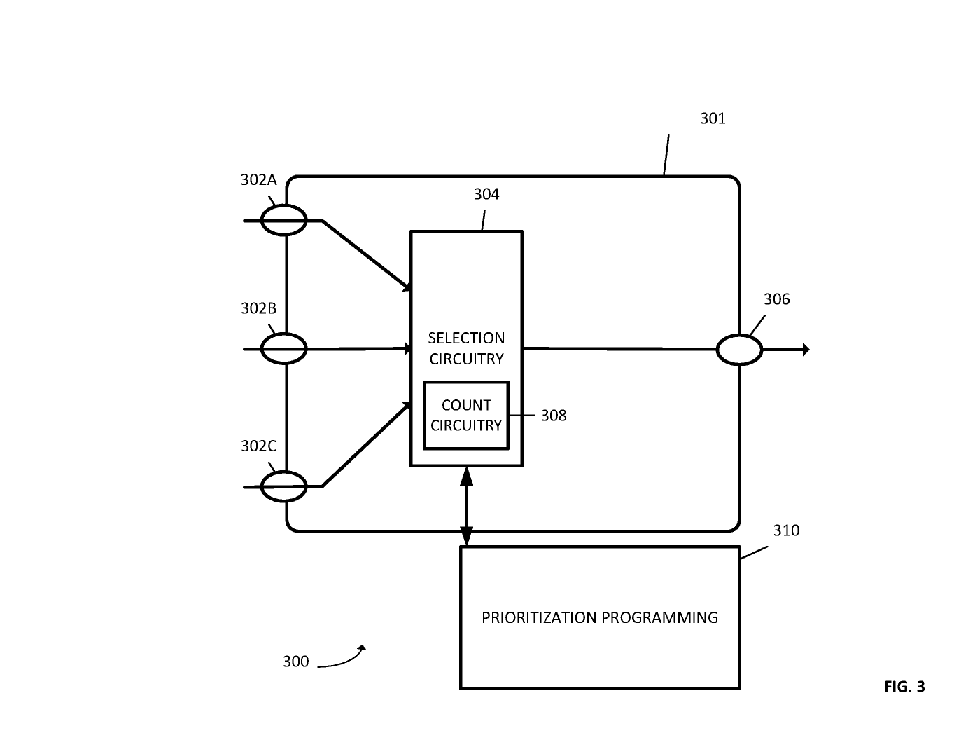

FIG. 3 is a flow diagram 300 performed using circuitry 301 of a network switch, such as the network switch 106. For instance, the circuitry 301 may be in at least one of the one or more ASICs 202 of the network switch 106. As illustrated, the circuitry 301 receives incoming data packets at ingress ports 302A, 302B, and 302C (collectively referred to as in ports 302). The in ports 302 may be any connection within the network switch 106 and/or to any external device. For instance, the in ports 302A and 302B may be respectively coupled to the data source 102 and the data source 104.

The ingress ports 302, directly or through other circuitry, couple to selection circuitry 304 that is used to select which packets from the in ports 302 are to be transmitted to an egress port 306. The egress port 306 may be used to transmit the selected packets to an external device and/or another location within the network switch 106, such as the destination 108.

As discussed below, the circuitry 301 includes count circuitry 308 that counts transmitted flits of the selected packets transmitted to the egress port 306. The count circuitry 308 also counts the number of packets, data, and flits used from each data source via the ingress ports 302. For instance, the count circuitry 308 may track a first number of unfilled flits that have at least one segment that is unused. Additionally or alternatively, the count circuitry 308 may track numbers of total amounts of segments sent from each source. Also, the count circuitry 308 may track the total number of flits sent from the selection circuitry 304. As illustrated, the count circuitry 308 may be implemented as part of the selection circuitry 304. In some implementations, the count circuitry 308 may be implemented outside of the selection circuitry 304. Regardless of whether the count circuitry 308 is part of the selection circuitry 304 or is external to the selection circuitry 304, the selection circuitry 304 selects which packets to transmit from the in ports 302 to the out port 306 based on the count(s) tracked in the count circuitry 308.

In addition to or alternative to counting each of the transmitted flits, each of the unfilled flits, and the total number of transmitted segments or packets from each source, the count circuitry 308 may implement a single index that tracks the number of unfilled flits and total number of flits in a combined manner. The index may change in one direction (e.g., a decrement) when a flit is transmitted and may change in another direction (e.g., an increment) when a segment of a transmitted flit is unfilled. Furthermore, the movements of the index in the different directions may include different values. For instance, the decremented value for a transmitted flit may be a unit value (e.g., 1) while the incremented value for a transmitted unfilled flit may be a multiple of the unit value (e.g., 5). In some embodiments, the incremented value may be programmable using prioritization programming 310.

The prioritization programming 310 (e.g., the same as the prioritization programming 210 of FIG. 2) may be implemented using processing resource(s) of a network device. For instance, the prioritization programming 310 may be implemented as the prioritization programming 210 of FIG. 2 using the processing resource(s) 208 of the computing system 200 of FIG. 2. Additionally or alternatively, the values may be set using mode registers and/or other mechanisms that may be used to set the incremented value. By programming the incremented value, the “cost” of an unfilled segment may be assigned. This indicates how many unfilled flits may be tolerated when prioritizing fairness.

The index may be capped in one or both directions, such as a minimum where the index is no longer decremented or a maximum where the index is no longer incremented when a flit is transmitted. As repeated unfilled flits are sent with at least one empty segment, the index may continue to trend in a direction away from this minimum or maximum.

A threshold may be programmed by the prioritization programming 310 to indicate how much bandwidth inefficiency is acceptable for the sake of fairness in drawing from two or more sources. This threshold may be used by the selection circuitry 304 to prioritize fairness or bandwidth as competing considerations. When the index is on one side of (e.g., below) the threshold, the selection circuitry 304 may prioritize fairness between the sources while prioritizing bandwidth usage when the index is on the other side of (e.g., above) the threshold. Different implementations may prioritize fairness or bandwidth usage when the index is equal to the threshold. For instance, some implementations may prioritize bandwidth usage while the index is equal to the threshold, other implementations may prioritize fairness while the index is equal to the threshold, and yet other implementations may leave prioritization the same (e.g., fairness or bandwidth usage) as a current prioritization when the index is equal to the threshold and changing the prioritization after the threshold has been crossed.

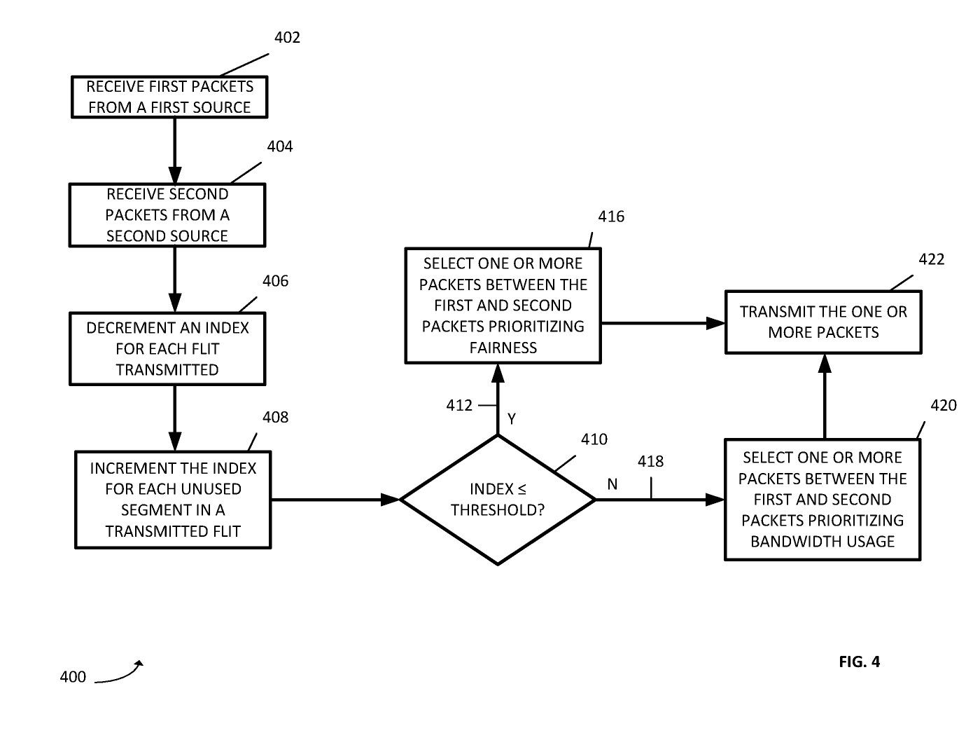

FIG. 4 is a flow diagram of a process 400 that may be performed by a network device (e.g., the network switch 106, the computing device 200, and the circuitry 301) that receives packets from multiple sources. For instance, the network device may be a network switch that receives data from two network devices external to the network switch. Additionally or alternatively, the network device may have multiple internal sources that are different pathways through the network device. The process 400 may be implemented using the circuitries 401, the ASIC(s) 202, the processing resource(s) 208, and/or the selection circuitry 304.

A part, such as one of the circuitries 401, of a network device receives first packets from a first source (block 402). The first packets may be received at an input port, such as the in ports 302, from another network device external to the network device and/or may be received at one of the circuitries 301 from another one of the circuitries via an inter-circuitry fabric. In other words, the network device may be a chassis network device that includes multiple different components, such as the circuitries 301 and/or the ASIC(s) 202.

The part of the network device receives second packets from a second source (block 404). Like the first packets, the second packets may be received at an input port, such as the in ports 302, from another network device external to the network device and/or may be received at one of the circuitries 301 from another one of the circuitries via an inter-circuitry fabric.

In some implementations, the first packets and the second packets may be received at the same time and/or at completely different times. For instance, the first packets may be received after the second packets are received but before the second packets can be sent. Similarly, the second packets may be received after the second packets are received but before the first packets can be sent. Further, in some implementations, at least some of the first packets and at least some of the second packets are co-pending in that both pending to be transmitted from the network device at the same time causing the network device to select between the different packets.

During operation, the network device may have transmitted previously received packets. The network device then decrements an index for each flit transmitted of these previously received packets (block 406). For instance, the count circuitry 308 of selection circuitry 304 of circuitry 301 may decrement the index by a first value for each flit transmitted on each clock cycle if data is available to be transmitted. Furthermore, in some implementations, the count circuitry 308 may also decrement the index for clock cycles where no packets are transmitted because there is no pending data to transfer. In certain implementations, the index may have a minimum value (e.g., 0) where a decrement of the index when at the minimum value results in the index remaining at the minimum value. In some implementations, the value decremented may be a first value (e.g., 1).

The network device also increments the index for each unused segment in a transmitted flit (block 408). In other words, if one part of the flit (e.g., 1 of 2 segments) is empty in the transmitted flit, the index is incremented once by a second value. However, if multiple parts of the flit (e.g., 2 of 3 segments) are empty, the index may be implemented multiple times by the second value. This index incrementation may also be performed using the same circuitry, such as the count circuitry 308, used to perform the decrement of the index. The amount incremented for transmissions with unused/empty segments may be different than the first value decremented when any transmission is sent. For instance, the increment value may be a “cost” of an empty packet indicating how often such transmissions may be used in relation to a threshold. For instance, the increment value may be a second value (e.g., 5) while the decrement value is the first value (e.g., 1). In some implementations, the first value and/or the second value may be programmable. For instance, the processing resource(s) 208 may receive an input (e.g., via an I/O interface 212) and program the first and/or second value as the received input.

In the illustrated implementation, a transmitted packet may cause the circuitries 401 to decrement the index by the first value and increment the index by the second value for the same transmitted packet. In further implementations, the decrement of the index may be for full flits while the increment of the index may be for partially empty flits, but the second value may be less (e.g., 4 instead of 5) to achieve similar results. In some implementations, transmissions of flits may result in an increment to the index, and the transmission of the unused segments may result in a decrement to the index.

To determine which of the first packets or the second packets are to be transmitted, the network device determines whether the index is less than or equal to a threshold (block 410). For instance, the selection circuitry 304 with count circuitry 308 may determine whether the index is greater than or equal to the threshold. The threshold indicates how much fairness may be prioritized at the expense of potential bandwidth usage by defining the tolerance for how inefficient transmission may be for the sake of fairness. This allowance of some bandwidth inefficiency may be due to the ability of internals (e.g., circuitry 4301) to operate above a target performance threshold. For instance, internal multiplexing of data may be performed at a rate that is faster (e.g., 20% faster) than the target providing some leeway to prioritize fairness at least a part of the time. However, when the performance falls below this level, fairness may no longer be emphasized over bandwidth usage. This level may be commensurate with a threshold for the index. For instance, the threshold of the index may be set to make sure that the level is still met even when fairness is applied. In other words, the threshold makes sure that a fairness-priority-based mechanism does not cause the performance of the network device to fall below the level. For instance, the threshold may be set to a value that enables the network device to maintain operation at or above the target level.

In some implementations, the threshold may be programmable. For instance, the processing resource(s) 208 may receive an input (e.g., via an I/O interface 212) and program the threshold as the received input.

If the threshold is less than or equal to the threshold (412), selection circuitry of the network device (e.g., multiplexers or other selective components of selection circuitry 304) selects one or more packets between the first and second packets while prioritizing fairness (block 416). Thus, as long as the index is not greater than the threshold, a fairness-priority-based mechanism may be used since fairness is permitted since the performance threshold has been/is currently being achieved.

If the threshold is greater than the threshold (418), the selection circuitry (e.g., selection circuitry 304) selects one or more packets between the first and second packets while prioritizing bandwidth usage (block 420). Thus, when the index crosses the threshold, the selection circuitry switches to a bandwidth-usage-priority mechanism. In other words, when the index indicates that efficiency of the network device has fallen or risks falling below a performance level, packets are selected that maximize bandwidth usage even if such selections end up being unfair between two or more sources.

In the illustrated implementation, when the index is equal to the threshold, the fairness priority is applied. In other implementations, the bandwidth usage priority may be applied when the index is equal to the threshold. In further implementations, this condition may be dynamic where the index being equal to the threshold causes the selection circuitry to keep using whatever mechanism that it was previously using before the index became equal to the threshold. After the index continues past being equal to the threshold, does the selection circuitry change how it selects packets between two or more sources.

Moreover, in the illustrated implementation, one threshold may be used for switching from the fairness-priority-based mechanism to the bandwidth-usage-priority-based mechanism and vice versa. In other implementations, a first threshold may be used to switch from prioritizing fairness to prioritizing bandwidth usage, and a second threshold may be used to switch from prioritizing bandwidth usage to prioritizing fairness. This difference in thresholds may enable the bandwidth efficiency to return to a level above a target level before re-enabling fairness prioritization. As such, the threshold for switching back to prioritizing fairness may be lower than the threshold for switching to prioritizing bandwidth usage from previously prioritizing fairness.

Finally, the network device or a portion of the network device, such as the selection circuitry, transmits the one or more packets selected by the selection circuitry (block 422). For instance, the selected one or more packets chosen using fairness prioritization or bandwidth usage prioritization are transmitted to another part of the network device and/or outside of the network device to an external device via an output (e.g., out port 306). As part of transmitting the one or more packets, the count circuitry (e.g., count circuitry 308) of the network device increments or decrements the index based on whether the flit(s) transmitting the one or more packets are full or at least partially empty with unused segment(s).

In the illustrated implementation, two sources and respective packets are received with the network device selecting between the two sources. However, such techniques are applicable to any suitable number of sources. For instance, the process 400 may be applicable in selecting between third packets from a third source in addition to the first and second packets from the first and second sources and so on.

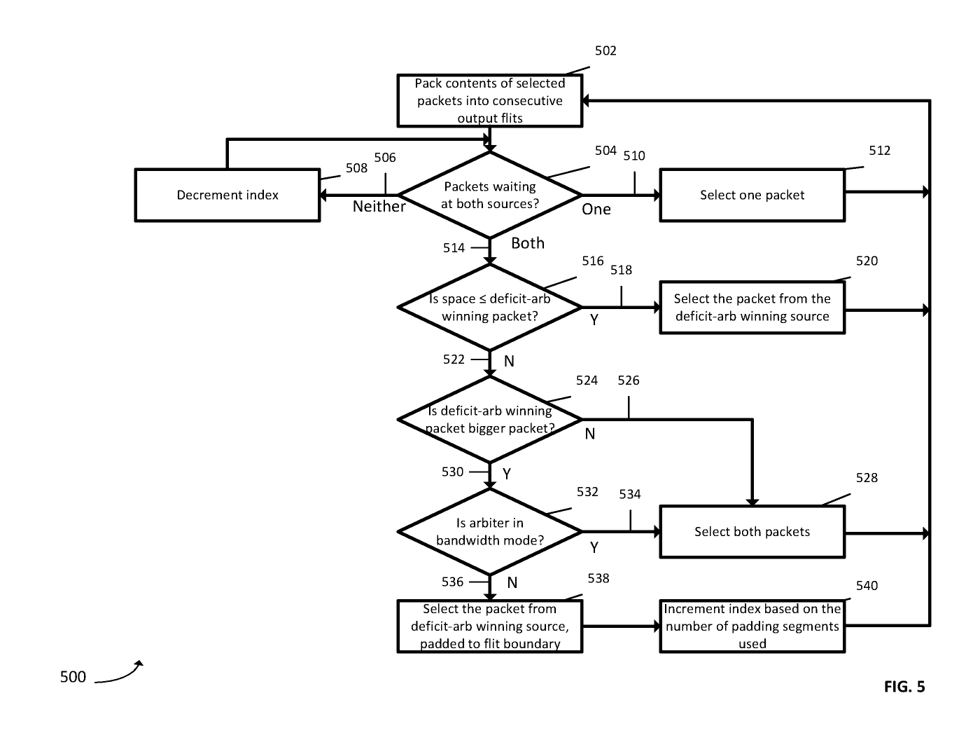

FIG. 5 is a flow diagram of a process 500 that may be used in selecting packets for transmission for packing contents of selected packets into consecutive output flits by a network device (block 502). The process 500 may be an additional or alternative representation of how to pack contents compared to the process 400 of FIG. 4. Each time one flit is transmitted, whether it includes unused segments or not, the index is decremented.

The network device (e.g., the processing resource(s) 208 and/or the ASIC(s) 202) determines whether packets are waiting at both sources (block 504). If packets are waiting at neither source (506), the index is decremented (block 508). For instance, the count may be decremented by a decrement amount (e.g., 1) for each clock cycle where no flit is transmitted because no data is pending to be transmitted.

If a packet is waiting at one source (510), the network device selects the waiting packet for transmission (block 512). After selecting the packet, it is packed and transmitted in a corresponding flit (block 502). The network device then checks whether other packets are waiting by returning to block 504.

If packets are waiting at both sources (514), the network device determines whether the remaining space in the output flit is less than or equal to the length of the deficit-arbitration-winning packet (block 516). In other words, the network device determines whether there will be additional space to be packed after the packet is inserted into the flit. If the space is smaller than or equal to the length of the deficit-arbitration-winning packet (518), the network device selects the deficit-arbitration-winning packet (block 520). Because no additional space is to be filled in this situation, the deficit-arbitration-winning packet may be selected without any other packets selected for the flit since there is no space for other packets. The deficit-arbitration-winning packet is packed into the flit and transmitted (block 502) and the process 500 returns to block 504 for selecting next packet(s).

If there is space in the flit larger than the deficit-arbitration-winning packet (522), the network device determines whether the deficit-arbitration-winning packet is the larger of the waiting packets (block 524). If the deficit-arbitration-winning packet is not the bigger of the two packets (526), the network device selects both packets (block 528). These packets are packed into the flit and transmitted (block 502) and the process 500 returns to block 504 for selecting next packet(s).

If the deficit-arbitration-winning packet is the bigger of the waiting packets (530), the network device determines whether the arbiter is in a bandwidth mode (block 532). In other words, the network device may determine whether the index is above the programmable threshold to switch from fairness emphasis to bandwidth emphasis. If bandwidth is the emphasis, the arbiter is in the bandwidth mode.

If the arbiter is in the bandwidth mode (534), the network device may select both packets (block 528). These packets are packed into the flit and transmitted (block 502) and the process 500 returns to block 504 for selecting next packet(s).

If the arbiter is not in the bandwidth mode (536), the network device selects the deficit-arbitration-winning packet and pads to the flit boundary (block 538). In other words, part (e.g., a segment) of the flit is unused. Accordingly, the network device increments the index based on the number of padding segments used (block 540). For each padding segment used, the network device may increment the index by the programmable parameter (N). As such, if multiple padding segments are used, the incrementation of the index is the number of padding segments used times the programmable parameter.

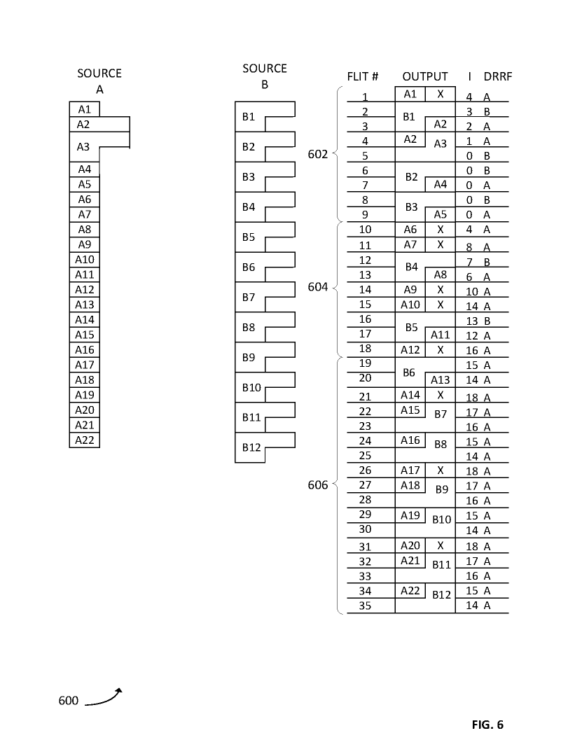

FIG. 6 is an example 600 of packet selection, and transmission that may be received at a network device, such as the network switch 106. The network device selects whether to transmit packets from multiple sources: source A and source B. Source A and source B may be devices that are external to the network device or may be different pathways in the network device. The network device may multiplex using selection circuitry whether next to transmit packets from source A or from source B each time it has inserted the end of the prior packet into an output flit. Each input and output flit is two segments wide. The example also shows an index. The index may be counted in the count circuitry 308.

Each of the packets from source A are labelled as A1, A2, A3, A4, A5, A6, A7, A8, A9, A10, A11, A12, A13, A14, A15, A16, A17, A18, A19, A20, A21, and A22 that are collectively referred to as “A packets.” As illustrated, packets A1 and A4-A22 are a single segments in length while packet A2 is two segments in length and packet A3 is three segments in length.

Each of the packets from source B are labelled as B1, B2, B3, B4, B5, B6, B7, B8, B9, B10, B11, and B12 that are collectively referred to as “B packets.” As illustrated, all of the B packets are three segments in length.

The example 600 also shows an output that uses a flit that is two segments wide. Unused segments within an output flit are marked with an X indicating that they are empty. The example 600 also shows a column representing the flit number of the flits transmitted from the network device.

The example 600 also shows the index in column I with a corresponding value after each flit is transmitted. The example 600 also shows which source deficit-round-robin or another deficit mechanism favors in column DRRF.

In the illustrated implementation, there are two sources: source A and source B for simplicity, but the techniques discussed herein may be applied to any number of sources, such as two, three, or more sources. For the purposes of discussion, a decrement value applied with transmission of each flit is 1, the increment value (N) may be programmed as 5, and the threshold (M) may be programmed as 15. These numbers are used for discussion, but other values may be used without varying from the teachings herein.

In the illustrated implementation, the first two columns, shows the stream of packets enqueued from each of the two-segment wide input sources A and B to be sent to the two-segment-wide output. The remaining columns show the flit number at the output, the input source (A or B) currently favored by the deficit round-robin arbitration (DRRF), the resulting segments that are sent at the output, and the index value (I) in effect after selecting those segments, which may influence the arbitration behavior in the following flit. In clock cycles where one output flit segment is empty, namely flits numbered 1, 10, 11, 14, 15, 18, 21, 26, and 31, the index increases by 4. This corresponds to a simultaneous or sequential increase by N=5 associated with the empty output segment and decrease by 1 attributable to the transmission of a flit. In all other flit transmissions, the decrease by 1 occurs without incrementing by 5 as net decrease of 1, but the index is still subject to a floor value of zero.

At any given time, the deficit round-robin arbiter compares the cumulative number of segments that have been previously selected from A to the cumulative number that have been previously selected from B. If the number selected from A exceeds the number from B, then B is favored, otherwise A is favored.

Each arbitration decision selects one or two entire packets for transmission to the output interface, and arbitration occurs in flits where the previously-selected packet(s) in the output have ended and a new packet is to be transmitted. The deficit round-robin favored packet is always selected, and the other packet is also selected with the deficit round-robin favored packet in certain situations.

No arbitration occurs in flits numbered 5, 23, 25, 28, 30, 33, and 35. In each of these cases, the packet data being sent at the output consists entirely of a continuation of an already-started packet, and so no new packet is to be selected.

Arbitration is used in cases where a packet that began in an earlier flit ends partway through the current flit. A new packet is to be selected to fill the remainder of the current flit. This is shown in flits numbered 3, 4, 7, 9, 13, 17, and 20. In each of these cases, the first segment being sent to the output is a continuation of an already-started packet, but a new packet is to be selected to begin in the second segment of the output flit. Since a single packet is to be selected in these clock cycles, choosing the deficit-round-robin winner simultaneously achieves optimum bandwidth and fairness.

In the remaining flits, 1, 2, 6, 8, 10, 11, 1214, 15, 16, 18, 19, 21, 22, 24, 26, 27, 29, 31, 32, and 34, the previous packet ended in the previous output flit, so arbitration is used to select at least one new packets to begin at the start of the current flit. In some of these cases, namely flits 2, 6, 8, 12, 16, and 19, the source favored by deficit-round-robin arbitration provides a packet sufficiently long to fill or exceed the output flit, so again the deficit-round-robin winner simultaneously achieves optimum bandwidth and fairness, without selecting a second packet. Flits 1, 10, 11, 14, 15, 18, 21, 22, 24, 26, 27, 29, 31, 32, and 34 are where the fairness override mechanism described is applicable. In these cases, the output flit has space for two segments, and the round-robin-favored source A provides a one-segment packet with the other source B offering a three-segment packet. If the arbiter selects the round-robin-favored source A alone, the output flit will be transmitted with an empty segment. This empty segment causes a waste of bandwidth but enhances fairness. On the other hand, if the arbiter selects both source A and B, no bandwidth will be wasted, but the two packets together will represent one segment of forward progress for source A and three segments for source B exacerbating the unfair advantage B already holds over A. Selecting both sources represents bandwidth-emphasizing behavior, and selecting the round-robin-favored source represents fairness-emphasizing behavior. To choose between these two options, the arbiter considers the value of the index relative to the programmable threshold (M). When the index is lower than or equal to the threshold, as in flits numbered 1, 10, 11, 14, 15, 18, 21, 26, and 31, the fairness-emphasizing mode is in effect, and the arbiter selects a single packet resulting in one unused segment in the output flit. When the index exceeds the threshold, as in flits numbered 22, 24, 27, 29, 32 and 34, bandwidth-emphasizing mode is in effect, and the arbiter selects packets from both A and B. In these cases, no segments are wasted in the output flits, but fairness may be compromised.

The example 600 can be broadly divided into three time ranges that illustrate different behaviors. Flits 1 through 9, demarcated 602, illustrate fairly typical network behavior with a somewhat random variety of packet lengths. The diversity of packet lengths allows the arbiter to effectively pack the output flits with deficit round-robin arbitration, very little waste, and very little unfairness.

During flits 10 through 18, demarcated 604, the input packets now form a somewhat pathological strictly repeating pattern containing no random variation. While such unvaried patterns seldom persist for long in networks, such patterns are to be handled correctly in the event they do persist. Lacking the random variations that were present in 602 and including single segment packets from A and three segment packets from B exposes the difficulty of maintaining both fairness and output bandwidth efficiency at once. To achieve better fairness, the arbiter selects three packets from A for every packet that it selects from B. And this is what it does, because it is still in fairness-emphasizing/priority mode since the index remains below the threshold (M) throughout 604. This causes many of the single-segment packets from A to be accompanied by unused segments in the output flit, wasting about 25% of output bandwidth. This exceeds the tolerable rate of one unused segment in five (20%) implied by the N=5 setting and is reflected in the gradual increase in the index value, climbing towards the M=15 threshold. If the pathological pattern is short-lived and more random packets lengths resume before the index reaches this threshold, there is an opportunity for fairness-emphasizing behavior to continue without interruption.

During flits 19 to 35, demarcated 606, the pathological pattern continues, and threshold M=16 has been reached by the index. The pathological pattern continues indefinitely, and 606 demonstrates how the arbiter handles it in a sustained steady state. During 606, the behavior alternates between bandwidth-emphasizing and fairness-emphasizing modes, as the index value alternates between brief periods above and below threshold M=15. When index exceeds M=15, bandwidth-emphasizing packing of output flits eliminates wasted segments, at the expense of fairness between sources A and B. The absence of empty segments allows the index to decline, until it reaches 15 or below resulting in a change back to fairness-emphasizing output flit packing. The increment N=5 defines a target bandwidth efficiency of 20%, one unused segment in five, matching the rate achieved from flit number 21 onwards. During the same time period from flit 21 onwards, source A makes 9 segments of forward progress to source B’s 18 segments. This behavior represents a best fairness possible consistent with a 90% bandwidth efficiency.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

What is claimed is:

1. A method, comprising:
receiving, at a network device, first packets from a first source;
receiving, at the network device, second packets from a second source;
decrementing, at the network device, an index by a first value for each flit transmitted by the network device;
incrementing, at the network device, the index by a second value for each of the flits transmitted with an unused segment by the network device;
selecting one or more packets from the first packets or the second packets to transmit from the network device, wherein the selection is configured to prioritize fairness between the first source and the second source when the index is less than or equal to a threshold and to prioritize bandwidth usage when the index is greater than the threshold; and
transmitting the selected one or more packets from the network device.

2. The method of claim 1, wherein the first value is less than the second value.

3. The method of claim 1, wherein prioritizing fairness comprises sending flits with empty segments when available segments are available for transmission but would increase an unfairness measure.

4. The method of claim 1, wherein prioritizing bandwidth usage comprises packing segments into flits regardless of whether packing the segments increases an unfairness measure.

5. The method of claim 1, wherein the first source and the second source comprise different paths inside of the network device that include multiple internal sources with pathways that are part of a fabric of pathways of the network device, and the network device comprises a chassis network device.

6. The method of claim 1, wherein the first source is a second network device external to the network device, and the second source is a third network device external to the network device and the second network device.

7. The method of claim 1, comprising prioritizing bandwidth usage after the index has crossed the threshold until the index crosses a second threshold, wherein the second threshold is lower than the threshold.

8. The method of claim 1, comprising incrementing the index by the second value an additional time when a transmitted flit has multiple unused segments.

9. The method of claim 1, comprising:
receiving, at the network device, an input; and
programming the input as the value.

10. The method of claim 1, comprising:
receiving, at the network device, an input; and
programming the input as the threshold.

11. The method of claim 1, comprising receiving, at the network device, third packets from a third source, wherein selecting the one or more packets comprises selecting from the first packets, the second packets, or the third packets to output from the network device, wherein the selection is configured to prioritize fairness between the first source, the second source, and the third source when the index is less than or equal to the threshold and to prioritize bandwidth usage when the index is greater than the threshold.

12. A network device, comprising:
one or more input ports configured to receive a plurality of packets from a plurality of source devices;
selection circuitry configured to:
receive the plurality of packets from the one or more input ports;
select transmission packets from the plurality of packets from the plurality of source devices using a first prioritization scheme when an index is less than or equal to a threshold; and
select transmission packets from the plurality of packets from the plurality of source devices using a second prioritization scheme when the index is above the threshold; and
one or more output ports configured to transmit the transmission packets as transmitted flits.

13. The network device of claim 12, wherein the first prioritization scheme comprises prioritizing fairness, and the second prioritization scheme comprises prioritizing bandwidth usage.

14. The network device of claim 13, wherein the first prioritization scheme permits more unused segments in the transmitted flits than the second prioritization scheme.

15. The network device of claim 12, wherein the index is based at least in part on a first number of transmitted flits and a second number of unused segments of the transmitted flits.

16. The network device of claim 15, comprising count circuitry configured to:
decrement the index for each of the transmitted flits; and
increment the index by an amount for each unused segment transmitted in a corresponding flit.

17. The network device of claim 16, comprising at least one processing resource, and the amount is a programmable value by the at least one processing resource.

18. A network device, comprising:
one or more input ports configured to receive a plurality of packets from a plurality of source devices; and
selection circuitry comprising count circuitry and configured to:
receive first packets from a first source;
receive second packets from a second source;
decrement, at the count circuitry, an index for each flit transmitted;
increment, at the count circuitry, the index by a value for each unused segment transmitted in a corresponding flit;
select one or more packets from the first packets or the second packets to output from the network device, wherein the selection is configured to prioritize fairness between the first source and the second source when the index is less than or equal to a threshold and to prioritize bandwidth usage when the index is greater than the threshold; and
transmit the selected one or more packets from the network device.

19. The network device of claim 18, wherein the first source and the second source comprise different pathways inside of the network device.

20. The network device of claim 18, comprising at least one processing resource configured to:
receive an input; and
program the received input as the threshold.
